(19) United States
(12) Patent Application Publication
(10) Pub. No.: US 2019/0281837 A1
(43) Pub. Date: Sep. 19, 2019

(54) TNT-Tick Natural Terminator

(71) Applicant: Janice Lyon, Honeoye Falls, NY (US)

(72) Inventor: Janice Lyon, Honeoye Falls, NY (US)

(21) Appl. No.: 15/923,647

(22) Filed: Mar. 16, 2018

(51) Int. Cl. A01N 65/22

(52) U.S. Cl. CPC A01N 65/22

(57) ABSTRACT

The present invention is a natural method to kill insects and ticks on animals and humans. It is non-toxic under general use to the applicator and the treated animal. When used as directed, the current invention will come in contact with and kill small insects and ticks that would otherwise go unnoticed. The present invention is unique because of the presence of dried ground mint which repels aphids, white flies, and others; dried ground oregano which repels most insects; food grade silicon dioxide which adheres to insect and tick exoskeletons as they crawl through it, dehydrating their exoskeletons, which kills them mechanically instead of chemically. Current products are applied to the top of the fur or clothing. Tick nymphs crawl on animals and humans unnoticed under the fur, hair or clothing. The invention can be applied to pastures, pet living/sleeping areas, and hunting stands through a dust applicator or shaker.

The present invention is an insect and tick product of natural ingredients for use on animals and humans. Components of the invention are non-heat processed food grade silicon dioxide and dried ground mint and dried ground oregano which are configured with a ratio of 8:1:1 and blended by tumbling together. It is brushed onto and through animal fur with skin contact, and applied to animal dwellings through a duster or shaking it onto desired areas to repel and kill insects and ticks that can carry diseases. It is non-toxic on the treated animal or human, or if the animal/human should lick the area where it is applied, or inhale small amounts under general use. It is generally safer to apply than chemical sprays and powdered chemical products. It is environmentally friendly in that birds and frogs use the main ingredient at will, and it is readily available in natural settings.

### BACKGROUND OF THE INVENTION

The present invention is an insect and tick repellent and killer made of all natural ingredients for use on animals. Most other natural products simply repel biting insects. The current invention is more effective and less toxic than current natural products available for such use. It is also more environmentally friendly in that birds and frogs use the main ingredient to help bone development and it is readily available in natural settings.

I: The present invention is unique in that it not only repels, but additionally kills insects and ticks that can carry disease to animals and humans using only naturally occurring materials with minimum processing. Animal owners groom their pets to remove dirt and grime. In nature, most animals roll in dirt or sand and grind it into their coats to relieve themselves of biting insects and ticks. Currently animal owners are inclined to use all natural, nontoxic products whenever they can be effective. The current invention is non-toxic, virtually non allergic, and contains only natural ingredients. It not only repels but also kills any insect, mite, or tick that crawls through the product. It is safer for the human applying the product than the existing toxic sprays. It can be used safely on horses, dogs, cats, humans, and other animals because the repelling herbs included are safe for animal contact and ingestion in the amounts present. Additionally it is applied in a method that allows it to come into contact with more insects and ticks that crawl through the hair of the animal and under human clothing than current topical sprays or powders.
